(19) United States
(12) Patent Application Publication
(10) Pub. No.: US 2007/0132922 A1
(43) Pub. Date: Jun. 14, 2007

(54) Liquid crystal display module for dual display and mobile communication terminal using the same

(75) Inventor: Chang-Ki Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/637,361

(22) Filed: Dec. 12, 2006

(30) Foreign Application Priority Data
Dec. 12, 2005 (KR) 2005-0121675

(51) Int. Cl. G02F 1/1335

(52) U.S. Cl. 349/113

(57) ABSTRACT

An LCD module applicable to various devices is disclosed. The LCD module includes a color filter substrate on which color filter patterns are arranged; a TFT substrate spaced apart from the color filter substrate at a predetermined distance and having one side on which TFT electrodes are arranged, wherein liquid crystal is filled between the color filter substrate and the TFT substrate; a first reflective plate installed outside the TFT substrate at a predetermined distance therebetween and selectively serving as a reflective plate; a second reflective plate installed outside the color filter substrate at a predetermined distance therebetween and selectively serving as a reflective plate; and a lamp installed at a side of the LCD module and emitting particular light. Accordingly, using the single LCD module, images can be displayed on both sides of the display device.

### PRIORITY

This application claims priority under 35 U.S.C. § 119 to an application entitled “Bidirectional Liquid Crystal Display and Mobile Communication Terminal Using the Same” filed in the Korean Intellectual Property Office on Dec. 12, 2005 and assigned Serial No. 2005-121675, the contents of which are incorporated herein by reference.

### BACKGROUND OF THE INVENTION

1. Field of the Invention

The present invention relates generally to a liquid crystal display (LCD) module for dual display, and more particularly, to an LCD module for dual display and a mobile communication terminal using the same, which can reduce a volume and a manufacturing cost of the mobile communication terminal.

2. Description of the Related Art

With the recent development of electronics and information communication technologies, most communication apparatuses are necessarily provided with display devices. The display device is used as a data input/output device and is gaining in importance.

An LCD module is widely used as the display device because of its slim profile, its light weight and its low power consumption characteristics. Also, a color display device is being gradually developed by the recent introduction of a thin film transistor liquid crystal display (TFT-LCD).

In general, a conventional LCD module is configured to display an image on only one side. Such an LCD module includes a color filter substrate on which color filters are formed, a TFT substrate on which TFT electrodes are formed, and liquid crystal filled therebetween, and displays a desired image by selectively transmitting light according to an applied current.

The LCD module configured as above is used in various kinds of devices, for example, portable wireless terminals, MP3 players, and electric home appliances.

However, the conventional LCD module has the following problems. To make images displayed in both directions, two LCD modules have to be mounted on front and rear surfaces of a printed circuit board (PCB), respectively. However, the mounting of the two LCD modules causes an increase in the thickness and volume of the device and complicates a control design for controlling each of the LCD modules. Also, a manufacturing cost is increased.

### SUMMARY OF THE INVENTION

An object of the present invention is to substantially solve at least the above problems and/or disadvantages and to provide at least the advantages below. Accordingly, an object of the present invention is to provide an LCD module capable of dual display and a mobile communication terminal using the same.

Another object of the present invention is to provide an LCD module capable of dual display and a mobile communication terminal using the same, which can reduce a thickness and volume of the terminal and a manufacturing cost thereof.

A further object of the present invention is to provide an LCD module capable of dual display and a mobile communication terminal using the same, which can simplify a control design for the LCD module.

According to an aspect of the present invention, an LCD module for dual display includes a color filter substrate on which color filter patterns are arranged; a TFT substrate spaced apart from the color filter substrate at a predetermined distance and having one side on which TFT electrodes are arranged, wherein liquid crystal is filled between the color filter substrate and the TFT substrate; a first reflective plate installed outside the TFT substrate at a predetermined distance therebetween and selectively serving as a reflective plate; a second reflective plate installed outside the color filter substrate at a predetermined distance therebetween and selectively serving as a reflective plate; and a lamp installed at a side of the LCD module and emitting light.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view illustrating a mobile communication terminal in a closed state according to the present invention;

FIG. 2 is a perspective view illustrating a mobile communication terminal in an opened state according to the present invention;

FIG. 3 is a cross-sectional view illustrating a main part of an LCD module according to the present invention; and

FIG. 4 is a cross-sectional view illustrating a case where first and second reflective plates serve as a transparent plate and a reflective plate.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

To describe the present invention, a folder type mobile communication terminal is illustrated and described. However, the present invention is not limited thereto, but may be applied to various devices using LCD modules for dual display. For example, a mobile communication terminal employing an LCD module for dual display according to the present invention may be a bar type terminal, a folder type terminal, a flip-up type terminal, a pop-up type terminal, a slide type terminal, a slide and rotation type terminal, or a slide and folder type terminal.

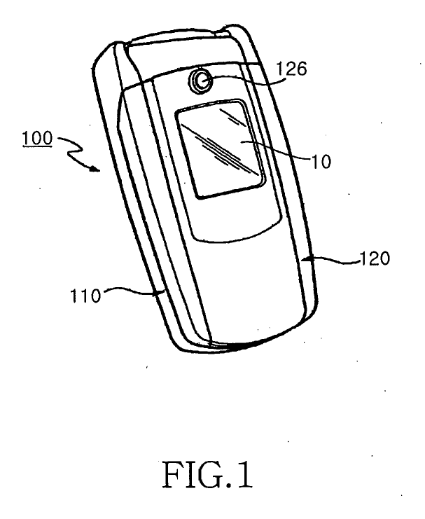

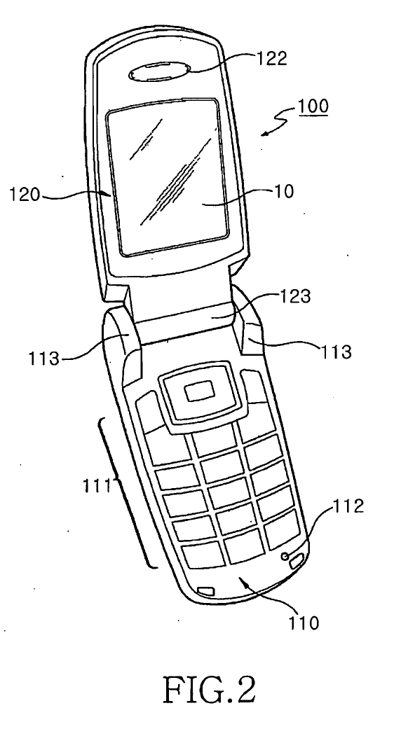

FIG. 1 is a perspective view illustrating a front side of a mobile communication terminal in a closed state, and FIG. 2 is a perspective view illustrating the mobile communication terminal in an opened state according to the present invention. Referring to FIGS. 1 and 2, the mobile communication terminal includes a main body 110, a folder 120 installed on the main body to be openable/closable at a predetermined angle, and a hinge module (not shown) opening/closing the folder 120 from/to the main body 110 at a predetermined angle (in general, about 130-140°). The hinge module is installed on a center hinge arm 123 of the folder 120, and a dummy of a hinge shaft protruding from an end portion of the hinge module is fixed to one of both side hinge arms 113 of the main body 110, so that the opening/closing operation of the terminal 100 can be performed.

The main body 110 includes a keypad assembly 111 and a microphone 112. The keypad assembly 111 having a navigation key button is installed as a data input unit and the microphone 112 is installed below the keypad assembly 111. The microphone 112 is a voice transmitter that transmits a voice of a user to another party. Also, the folder 120 includes a main display unit 10 and a speakerphone 122. The main display unit 10 is a data output unit and the speakerphone 122 is a voice receiver that receives a voice of the other party. Also, a sub display unit 10 may be installed on an outer surface of the folder 120, and a camera 126 for capturing an object upon selective manipulation of the user is installed above the sub display unit 10.

The reference numeral ‘10’ is used to refer to both the main display unit and the sub display unit because a single LCD module is capable of dual display according to the present invention. Hereinafter, the same reference numeral as that of the LCD module will be used to refer to the display unit.

According to the present invention, the main LCD module and the sub LCD module are configured to serve as a single LCD module. Therefore, a control unit may selectively operate the main LCD module and the sub LCD module, depending on whether the terminal is in an opened state or a closed state. For example, the control unit operates the sub LCD module when the terminal is in the closed state as illustrated in FIG. 1, and operates the main LCD module when the terminal is in the opened state as illustrated in FIG. 2.

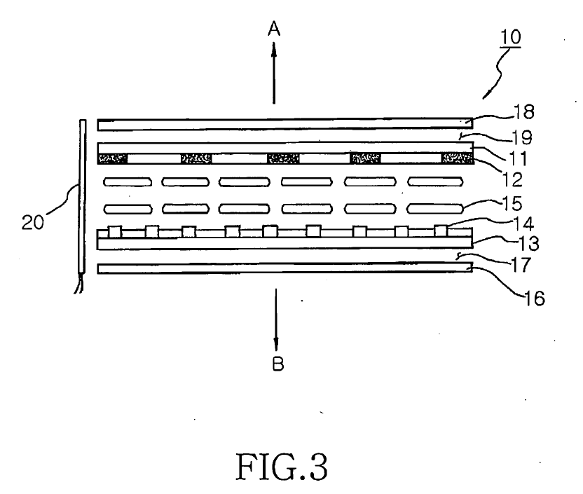

FIG. 3 is a cross-sectional view illustrating a main part of the LCD module according to the present invention. In FIG. 3, a color filter substrate 11 and a thin film transistor (TFT) substrate 13 are installed at a predetermined distance therebetween. A plurality of color filter patterns 12 are arranged on the color filter substrate 11, and a plurality of TFT electrodes 14 are arranged on the TFT substrate 13. Liquid crystal is filled in a space defined between the color filter substrate 11 and the TFT substrate 13. When a current is applied to a TFT electrode 14, liquid crystal molecules are arranged according to the applied current and thus selectively transmit light, thereby displaying an image.

A first reflective plate 16 is disposed outside the TFT substrate 13, leaving a predetermined space 17 (serving as a light-scattering layer) therebetween. The first reflective plate 16 is selectively operated as a transparent plate or a reflective plate according to the control of the control unit. Also, a second reflective plate 18 is installed outside the color filter substrate 11, leaving a predetermined space 19 (serving as a light-scattering layer) therebetween. Like the first reflective plate 16, the second reflective plate 18 is selectively operated as a transparent plate or a reflective plate according to the control of the control unit. For example, when the first reflective plate 16 is operated as the transparent plate, the second reflective plate 18 serves as the reflective plate to allow light to propagate in a direction B of FIG. 3 so that an image can be displayed through the TFT substrate 13. On the other hand, when the second reflective plate 18 serves as the transparent plate, the first reflective plate 16 serves as the reflective plate to allow light to propagate in a direction A of FIG. 3 so that an image can be displayed through the color filter substrate 11. Also, a lamp 20 having a predetermined length is installed at a side of the LCD module 10 as a light source in order to emit light to the spaces (i.e., light-scattering layers 17 and 19).

The space 17 between the TFT substrate 13 and the first reflective plate 16 and the space 19 between the color filter substrate 11 and the second reflective plate 18 perform a backlight function to scatter light emitted from the lamp 20 to the entire substrates. Even though air is used as a medium for light propagation in the spaces 17 and 19, the present invention is not limited thereto and other well-known propagation media may be used.

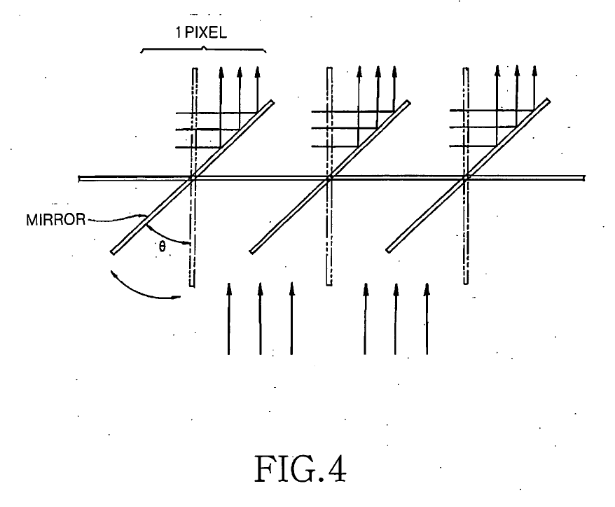

FIG. 4 is a cross-sectional view illustrating the case where the first and second reflective plates 16 and 18 serve as a transparent plate and a reflective plate.

As illustrated in FIG. 4, a plurality of rotatable mirrors may be installed at locations corresponding to respective unit pixels. The mirrors may be formed of aluminum and may be successively installed as individual chips, each corresponding to unit pixels. The angles of the mirrors may be controllable by electric signals applied to the respective unit pixels. The first and second reflective plates may serve as a transparent plate or a reflective plate, depending on the rotation of the mirror. Although not shown, a predetermined yoke or the like may be further provided to make the mirror rotatable on a fine frame constituting the plates, so that the rotation angle of the mirror can be adjusted according to the intensity of the electric signal.

For example, as illustrated in FIGS. 3 and 4, the light-scattering layer uniformly scatters light emitted from the lamp onto a screen of the LCD module. If mirrors of one of the first and second reflective plates 16 and 18 are rotated at an angle θ in FIG. 4, the light from the light-scattering layer is refracted and irradiated toward the adjacent TFT substrate or the color filter substrate. At this point, mirrors of the other plate are located as indicated by dash-dot-dot lines of FIG. 4, and thus the other plate serves as a transparent plate. The angle θ at which the mirror is rotated may be finely controlled according to the intensity of the applied electric signal. Preferably, the angle 0 falls within a range of 0-45°. In this case, the first or second reflective plate serves as a transparent plate when the mirrors are rotated at an angle of 0° and serves as a reflective plate when the mirrors are rotated at an angle of 45°.

As described above, according to the present invention, the single LCD module is capable of dual display, which contributes to reducing the thickness and volume and manufacturing cost of a mobile communication terminal, and facilitates control of the LCD module.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. An LCD (liquid crystal display) module for dual display, the LCD module comprising:
a color filter substrate on which color filter patterns are arranged;
a TFT substrate spaced apart from the color filter substrate at a predetermined distance and having one side on which TFT electrodes are arranged, wherein liquid crystal is filled between the color filter substrate and the TFT substrate;
a first reflective plate installed outside the TFT substrate at a predetermined distance therebetween and selectively serving as a reflective plate;
a second reflective plate installed outside the color filter substrate at a predetermined distance therebetween and selectively serving as a reflective plate; and
a lamp installed at a side of the LCD module and emitting light.

2. The LCD module of claim 1, wherein the first and second reflective plates selectively serve as a transparent plate or a reflective plate.

3. The LCD module of claim 2, wherein the second reflective plate serves as the reflective plate when the first reflective plate serves as the transparent plate, and the first reflective plate serves as a reflective plate when the second reflective plate serves as a transparent plate.

4. The LCD module of claim 1, wherein a space between the first reflective plate and the TFT substrate and a space between the second reflective plate and the color filter substrate serve as light-scattering layers through which light emitted from the lamp propagates.

5. The LCD module of claim 4, wherein a medium of the light-scattering layer is air.

6. The LCD module of claim 1, wherein the first and second reflective plates serve as a transparent plate or a reflective plate by a series of rotations of a plurality of mirrors being rotated by electrical signals.

7. The LCD module of claim 6, wherein the mirrors are placed perpendicular to the direction in which an adjacent substrate is installed to serve as a transparent plate, and the mirrors are inclined at a predetermined angle to serve as a reflective plate.

8. The LCD module of claim 7, wherein when the mirrors are inclined at an angle of 45°, the mirrors serve as a reflective plate.

9. The LCD module of claim 6, wherein the mirrors are formed of aluminum.

10. An LCD (liquid crystal display) module for dual display, the LCD module comprising:
a filter substrate on which filter patterns are arranged;
a TFT substrate spaced apart from the filter substrate at a distance and having one side on which TFT electrodes are arranged, wherein liquid crystal is filled between the filter substrate and the TFT substrate;
a first reflective plate installed outside the TFT substrate;
a second reflective plate installed outside the filter substrate; and
a lamp installed at a side of the LCD module.

11. A mobile communication terminal comprising:
an LCD (liquid crystal display) module including,
a filter substrate on which color filter patterns are arranged;
a TFT substrate spaced apart from the filter substrate at a distance and having one side on which TFT electrodes are arranged, wherein liquid crystal is filled between the filter substrate and the TFT substrate;
a first reflective plate installed outside the TFT substrate at a predetermined distance therebetween;
a second reflective plate installed outside the color filter substrate at a predetermined distance therebetween;
a lamp installed at a side of the LCD module and emitting light; and
a controller for controlling the LCD module.

12. A mobile communication terminal comprising:
an LCD (liquid crystal display) module including,
a color filter substrate on which color filter patterns are arranged;
a TFT substrate spaced apart from the color filter substrate at a predetermined distance and having one side on which TFT electrodes are arranged, wherein liquid crystal is filled between the color filter substrate and the TFT substrate;
a first reflective plate installed outside the TFT substrate at a predetermined distance therebetween;
a second reflective plate installed outside the color filter substrate at a predetermined distance therebetween;
a lamp installed at a side of the LCD module and emitting light; and
a controller for controlling the LCD module

13. The mobile communication terminal of claim 12, wherein the first and second reflective plates selectively serve as a transparent plate or a reflective plate.

14. The mobile communication terminal of claim 13, wherein the second reflective plate serves as the reflective plate when the first reflective plate serves as the transparent plate, and the first reflective plate serves as a reflective plate when the second reflective plate serves as a transparent plate.

15. The mobile communication terminal of claim 12, wherein the first and second reflective plates serve as a transparent plate or a reflective plate by a series of rotations of a plurality of mirrors being rotated by electrical signals.

16. The mobile communication terminal of claim 15, wherein the mirrors are placed perpendicular to the direction in which an adjacent substrate is installed to serve as a transparent plate, and the mirrors are inclined at a predetermined angle to serve as a reflective plate.

17. The mobile communication terminal of claim 16, wherein when the mirrors are inclined at an angle of 45°, the mirrors serve as a reflective plate.

18. The mobile communication terminal of claim 16, wherein the mirrors are formed of aluminum.
